(19) United States
(12) Patent Application Publication
(10) Pub. No.: US 2026/0222717 A1
(43) Pub. Date: Jul. 30, 2026

(54) SYSTEMS AND METHODS FOR DYNAMIC CONTROL OF MULTI-RATE OPTICAL NETWORK UNITS IN A PASSIVE OPTICAL NETWORK

(71) Applicant: Verizon Patent and Licensing Inc., Basking Ridge, NJ (US)

(72) Inventors: Denis A. Khotimsky, Westborough, MA (US); Jun Shan Wey, Sammamish, WA (US); David J. Baker, Mechanicsville, VA (US)

(73) Assignee: Verizon Patent and Licensing Inc., Basking Ridge, NJ (US)

(21) Appl. No.: 19/039,556

(22) Filed: Jan. 28, 2025

(51) Int. Cl. H04Q 11/00

(52) U.S. Cl. CPC H04Q 11/0067; H04Q 2011/0064; H04Q 2011/0079

(57) ABSTRACT

A device described herein, such as an Optical Line Terminal (“OLT”), may maintain association information that associates a plurality of identifiers with a plurality of transmission rates. The identifiers may include allocation identifiers (“Alloc-IDs”). The device may determine scheduling information for a particular Optical Network Unit (“ONU”) of an Optical Distribution Network (“ODN”), which may include determining different transmission rates for a plurality of different time slots. The device may determine a set of identifiers, of the plurality of identifiers, that are indicated in the association information as being associated with the transmission rates included in the scheduling information, and instruct the ONU to implement the scheduling information. Instructing the ONU to implement the scheduling may include providing the scheduling information with the set of identifiers to the ONU. The ONU may determine transmission rates for respective time slots based on the identifiers included in the scheduling information.

### BACKGROUND

A Passive Optical Network (“PON”) system is an optical access network that is typically based on a point-to-multipoint (“P2MP”) optical fiber topology, known as an Optical Distribution Network (“ODN”). An ODN uses fiber and passive components, such as splitters and combiners. A PON system uses the ODN to provide connectivity between a number of central nodes and a number of user nodes using bi-directional wavelength channels. A PON typically includes an Optical Line Terminal (“OLT”) at one end of the network, and multiple optical network units (“ONUs”) near the end users of the network. An optical signal is transmitted from the OLT via an optical fiber of the network and forwarded to each of multiple premises via one or more unpowered optical splitters.

In a single-channel time-division multiplexed (“TDM”) PON system, each ONU may operate over a single fixed wavelength channel associated with a particular OLT channel termination (“CT”) over a single ODN. In a time and wavelength division multiplexed (“TWDM”) PON system, an ONU may operate on a plurality of wavelength channels, one wavelength channel at a time. Each wavelength channel may be associated with its own OLT CT and a plurality of wavelength channels may be multiplexed over a single optical data network. ONUs may transmit data at different rates, where transmitting data at a higher rate consumes more power than transmitting data at a lower rate.

### BRIEF DESCRIPTION OF THE DRAWINGS

FIG. 1 illustrates an example overview of one or more embodiments described herein;

FIGS. 2A and 2B illustrate example associations between identifiers and transmission rates, in accordance with some embodiments;

FIG. 3 illustrates an example of scheduling a particular multi-rate ONU, in accordance with some embodiments;

FIG. 4 illustrates an example of different multi-rate configuration information associated with different ONUs, in accordance with some embodiments;

FIGS. 5 and 6 illustrate example processors for scheduling a particular multi-rate ONU, in accordance with some embodiments;

FIG. 7 illustrates an example environment in which one or more embodiments, described herein, may be implemented; and

FIG. 8 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for a multi-rate ONU that is capable of transmitting data at variable rates, which may be expressed in terms of bitrates, data rates, transmission rates, or the like. For example, the multi-rate ONU of some embodiments may transmit uplink data to a CT, a Central Office (“CO”), etc. at varying rates. In accordance with some embodiments, the ONUs may transmit data in a form of bursts, that is, precisely timed relatively short transmission. The ONUs may receive scheduling instructions (e.g., from a CT, a controller, and/or some other suitable source) specifying the parameters of each burst. The scheduling instructions to a conventional ONU may specify temporal parameters (e.g., particular transmission intervals, allocation intervals, allocations, time slots, burst windows, start time of transmission, end time or duration of the transmission, or the like) and overhead parameters (e.g., duration and pattern of preambles and delimiters). In some embodiments of the present invention, the scheduling instructions to a multi-rate ONU may additionally specify the transmission rate of each burst.

In this manner, the multi-rate ONU of some embodiments may be controlled, instructed, scheduled, etc. to transmit data at varying rates. The different rates may be selected based on factors such as power consumption factors, Quality of Service (“QoS”) or performance-based factors, or other suitable factors. In one example situation, a particular ONU may be instructed to reduce a transmission rate in order to reduce power consumption, where performance of the ONU (e.g., throughput or other performance metrics) remains at an acceptable level (e.g., exceeds one or more QoS thresholds). In another example situation, a particular ONU may be instructed to increase a transmission rate in order to increase performance (e.g., in order to meet one or more QoS thresholds), even at the expense of additional power consumption.

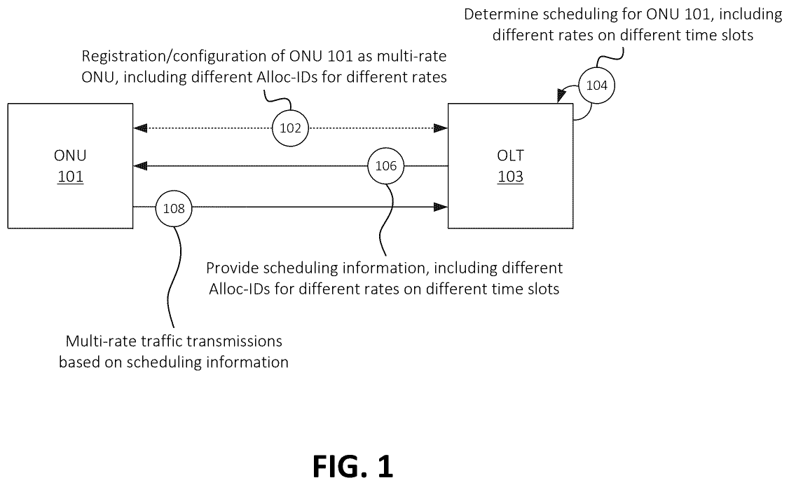

FIG. 1 illustrates an example overview of some embodiments. As shown, a particular multi-rate ONU 101 (hereinafter referred to simply as “ONU 101” for the sake of brevity) may be registered and/or configured (at 102) as a multi-rate ONU. ONU 101 may be a multi-rate ONU inasmuch as ONU 101 may have the capability of transmitting data (e.g., via optical signals) at different transmission rates. A “higher” transmission rate may refer to more data transmitted in a given timeframe, while a “lower” transmission rate may refer to less data transmitted in the same amount of time. As noted above, ONU 101 may further be capable of receiving instructions, scheduling information, etc. that specify when certain transmission rates are applicable (e.g., when to transmit data at given rates). In accordance with some embodiments, particular transmission rates may be associated with particular identifiers, such as allocation identifiers (“Alloc-IDs”). For example, a first transmission rate may be associated with a first Alloc-ID, a second transmission rate may be associated with a second Alloc-ID, and so on. As discussed below, Alloc-IDs may further delineate between different queues, flows, traffic types, etc. handled by ONU 101.

In some embodiments, ONU 101 may be registered and/or configured as part of an activation cycle during which ONU 101 is registered and/or configured for communications with OLT 103. During an activation cycle, communications between ONU 101 and OLT 103 (e.g., burst transmissions) may be conducted according to scheduling information that is applicable to a scheduling cycle that occurs during a time period associated with the activation cycle. One or more scheduling cycles may occur during an activation cycle. As further described herein, allocation identifiers may be used to vary the transmission rates used by ONU 101 for transmissions occurring in different scheduling cycles and/or within a single scheduling cycle.

In some embodiments, ONU 101 may be registered and/or configured with or by OLT 103. For example, OLT 103 may manage, configure, provision, etc. one or more ONUs 101. The registration and/or configuration (at 102) of ONU 101 may include, for example, identifying that ONU 101 is capable of transmitting data at multiple different transmission rates (e.g., that ONU is a multi-rate ONU or a multi-rate capable ONU). In some embodiments, OLT 103 may identify or assign different identifiers for multiple transmission rates at which ONU 101 may be instructed to transmit data. As noted above, such identifiers may be or may include Alloc-IDs.

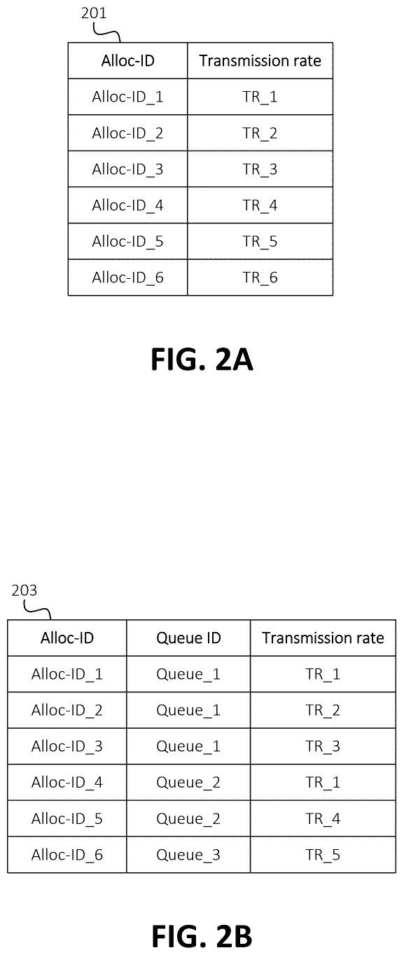

FIG. 2A illustrates example data structure 201, which may reflect the association of different identifiers with multiple transmission rates, in accordance with some embodiments. As shown, different Alloc-IDs may be associated with different transmission rates. For example, a first Alloc-ID (Alloc-ID_1) may be associated with a first transmission rate (TR_1), a second Alloc-ID (Alloc-ID_2) may be associated with a second transmission rate (TR_2), and so on. In some embodiments, data structure 201, and/or some or all of the information represented therein, may be maintained by ONU 101 and/or OLT 103.

FIG. 2B illustrates another example data structure 203, which may reflect the association of different identifiers with multiple transmission rates and one or more other attributes or characteristics, in accordance with some embodiments. In this example, ONU 101 may maintain or may otherwise be associated with multiple different queues, such as Queue_1, Queue_2, and Queue_3. In some implementations, OLT 103 may maintain queue status information associated with ONU 101, such as based on a registration operation, a configuration operation, a monitoring operation, or the like. The queue status information may include information such as identifiers of some or all queues maintained by ONU 101, queue status information, an amount of usage or capacity of queues maintained by ONU 101, or other suitable queue information.

In accordance with some embodiments, and as reflected in data structure 203, different identifiers (e.g., Alloc-IDs) may be assigned on a per-queue and a per-transmission rate basis. For example, Alloc-ID_1 may be associated with a first transmission rate (TR_1) for a first queue (Queue_1), and Alloc-ID_2 may be associated with a second transmission rate (TR_2) for the same first queue.

As further shown in FIG. 2B, different queues may be associated with different sets of transmission rates, which may be overlapping or non-overlapping sets of transmission rates. For example, Queue_1 and Queue_2 may both have identifiers for TR_1 (i.e., Alloc-ID_1 and Alloc-ID_4, respectively). In this manner, ONU 101 may be able to be instructed to transmit (e.g., as discussed below) traffic associated with Queue_1 and Queue_2 at TR_1. On the other hand, Queue_1 may have an identifier (i.e., Alloc-ID_3) for a third transmission rate (TR_3), while Queue_2 does not have an identifier associated with TR_3. In this manner, ONU 101 may be able to be instructed to transmit traffic associated with Queue_1 at TR_3, but may not be able to be instructed to transmit traffic associated with Queue_2 at TR_3. The different sets of transmission rates for different queues may be specified or determined for policy reasons, QoS reasons, and/or for other factors or considerations.

In some embodiments, data structure 203, and/or some or all of the information represented therein, may be maintained by ONU 101 and/or OLT 103. Further, while data structure 203 is provided in the context of different queues, other types of attributes or characteristics may be used in addition to or in lieu of queue identifiers, such as traffic type, service type, traffic priority level, or the like.

Returning to FIG. 1, OLT 103 may determine (at 104) scheduling parameters for ONU 101, including temporal information associated with bursts (e.g., start times of one or more bursts, end times of one or more bursts, durations of one or more bursts, or the like) and burst overhead parameters (e.g., duration and patterns of preambles and delimiters). In accordance with some embodiments, determining the scheduling parameters for ONU 101 may include determining different transmission rates for each burst. For example, as noted above, OLT 103 may determine the scheduling parameters for ONU 101 based on factors such as power consumption, QoS and/or performance metrics associated with ONU 101, and/or other suitable factors.

OLT 103 may provide (at 106) the scheduling information to ONU 101, such as via one or more control channels or other suitable interfaces between ONU 101 and OLT 103. The scheduling information may be provided to ONU 101 according to a scheduling cycle or other suitable cycle or interval. During a particular scheduling cycle, OLT 103 may provide scheduling instructions to ONU 101 for one or more burst windows. The burst windows may include or may be associated with one or more physical (“PHY”) layer frames or other types of time slots, time windows, time intervals (e.g., transmission intervals or allocation intervals), or the like. In one example, the scheduling instructions provided during a single scheduling cycle may include scheduling instructions for one single PHY layer frame, which may be 125 microseconds long in some implementations. In another example, the scheduling instructions provided during a single scheduling cycle may include scheduling instructions for two or more PHY layer frames (e.g., two, four, eight, and/or some other quantity). In some examples, scheduling instructions for two or more PHY layer frames may include scheduling instructions for a burst allocation series.

ONU 101 may accordingly output (at 108) multi-rate traffic transmissions (e.g., optical signals) based on the scheduling information. For example, ONU 101 may transmit traffic, associated with specified queues and/or other attributes, at transmission rates and at times specified by OLT 103 (e.g., as indicated in the scheduling information). In other words, ONU 101 burst windows during which ONU 101 outputs traffic may each be associated with a particular transmission rate specified by OLT 103, in accordance with some embodiments.

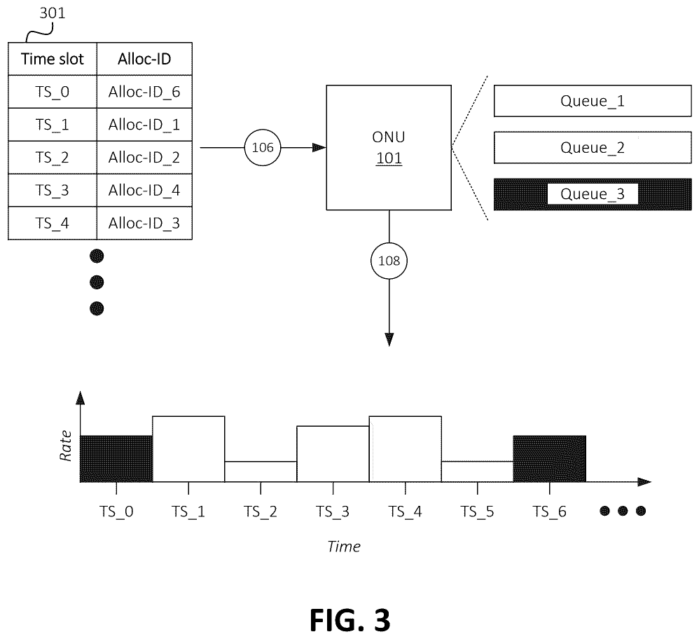

FIG. 3 illustrates an example of the above-mentioned scheduling information (provided at 106) and the multi-rate transmission (at 108) of traffic by ONU 101 based on the scheduling information. FIG. 3 is discussed in the context of example time slots TS_0 through TS_6. Although shown in the figure as equal-duration, contiguous time slots, some or all such time slots may be variable in duration and/or non-contiguous. For example, in some implementations, TS_0 may be a longer duration than TS_1 (and/or one or more other time slots), a shorter duration than TS_1, or an equal duration as TS_1. As another example, in some scenarios, TS_0 and TS_1 may be non-contiguous time slots (e.g., at least a threshold duration of time exists between the end of TS_0 and the beginning of TS_1). In such scenarios, the threshold duration of time between the beginning of one time slot and another time slot may reflect an allocation (e.g., one or more burst intervals, transmission intervals, time windows, or the like) for which a different ONU 101 is scheduled. In other scenarios, TS_0 and TS_1 may be contiguous time slots (e.g., no duration, or less than a threshold duration of time exists between the end of TS_0 and the beginning of TS_1). In some implementations, contiguous time slots may be referred to as a “burst allocation series.” Additionally, although referred to as “time slots,” concepts described herein may similarly apply to burst windows, timeframes, time intervals (e.g., transmission intervals or allocation intervals), or the like. Further, one “time slot” in the example of FIG. 3 may refer to an allocation series, multiple time slots, multiple time windows, or the like. Additionally, time slots may include or may be associated with overhead, padding, or the like (e.g., a preamble, a delimiter, etc.).

Further still, while presented in the context of one Alloc-ID per time slot, in some situations a time slot may be associated with multiple Alloc-IDs. For example, in an implementation where an example “time slot” refers to an allocation series (e.g., which may include multiple transmission intervals, multiple allocation intervals, etc.), a first transmission interval of the time slot may be associated with a first Alloc-ID (e.g., a first transmission rate associated with a first queue) and a second transmission interval of the time slot may be associated with a second Alloc-ID (e.g., the same first transmission rate associated with a second queue). For example, in some implementations, the multiple transmission intervals of a given time slot may be associated with a particular preamble, delimiter, etc., during which ONU 101 may be adjusted or configured to transmit data at a given transmission rate.

In the example of FIG. 3, data structure 301 may reflect example scheduling information provided to ONU 101 (e.g., by OLT 103). In accordance with some embodiments, data structure 301 may include specific Alloc-IDs that indicate particular transmission rates and/or that indicate particular transmission rates and queues, as well as temporal information such as transmission intervals, allocation intervals, time slots, time intervals, time windows, burst windows, etc. at which such transmission rates are applicable.

In this example, assume that ONU 101 implements example queues Queue_1, Queue_2, and Queue_3. As shown, ONU 101 may transmit or output (at 108) data from respective queues, on different time slots, at different transmission rates, as specified by data structure 301 (e.g., as specified by scheduling information provided by OLT 103). Referring to the example information shown in data structure 203 of FIG. 2B, the scheduling information (received by ONU 101 in FIG. 3) may specify Alloc-ID_6 for a first time slot (TS_0), based on which ONU 101 may transmit data, on TS_0, from Queue_3 at TR_5. As further shown, the scheduling information shown in data structure 203 may specify that a second time slot (TS_1) is associated with Alloc-ID_1. As such, on TS_1, ONU 101 may transmit data from Queue_1 at TR_1. As another example, the scheduling information may specify that a third time slot (TS_2) is associated with Alloc-ID_2. As such, on TS_2, ONU 101 may transmit data from Queue_1 at TR_2. Additionally, the scheduling information may specify that a third time slot (TS_3) is associated with Alloc-ID_4. As such, on TS_3, ONU 101 may transmit data from Queue_2 at TR_1. As discussed above, in this manner, ONU 101 may be granularly controlled (e.g., by OLT 103) to transmit data, such as data from specified queues, at different transmission rates.

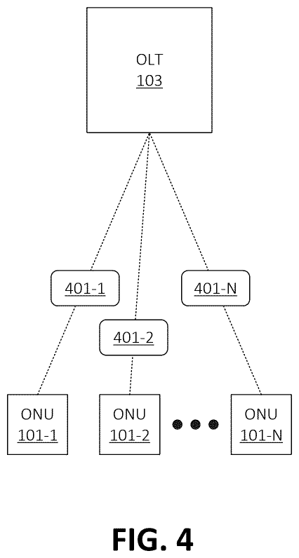

While the above example is described in the context of a single ONU 101, similar concepts may apply to multiple ONUs 101 (e.g., multiple ONUs 101 of an ODN). For example, as shown in FIG. 4, ONUs 101-1, 101-2, 101-N, and so on, may be associated with different multi-rate configuration information 401 (e.g., multi-rate configuration information 401-1, 401-2, and 401-N, respectively). In some embodiments, multi-rate configuration information 401-1 may include a first instance of data structure 201 and/or data structure 203, multi-rate configuration information 401-2 may include a second instance of data structure 201 and/or data structure 203, multi-rate configuration information 401-N may include an Nth instance of data structure 201 and/or data structure 203, and so on.

For example, multi-rate configuration information 401-1 may associate one or more particular identifiers (e.g., Alloc-IDs) with one or more respective transmission rates, and/or with one or more respective transmission rates and queue identifiers, as discussed above. Similarly, multi-rate configuration information 401-2 may associate one or more particular identifiers (e.g., Alloc-IDs) with one or more respective transmission rates, and/or with one or more respective transmission rates and queue identifiers. In this manner, different ONUs 101 may be configured differently, such that ONUs 101 may be dynamically instructed (e.g., by OLT 103) to transmit traffic (e.g., traffic associated with particular queues or other attributes) at different transmission rates, thus enhancing the configurability of an ODN or other suitable system that includes one or more ONUs 101.

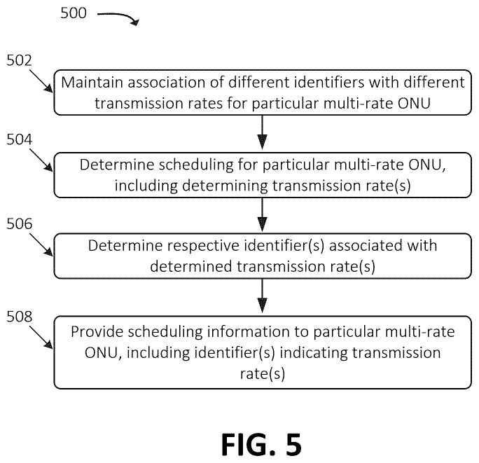

FIG. 5 illustrates an example process 500 for scheduling a multi-rate ONU (e.g., ONU 101), including determining transmission rate information. In some embodiments, some or all of process 500 may be performed by OLT 103, a controller, and/or some other suitable device or system.

As shown, process 500 may include maintaining (at 502) association information, which may include an association of different identifiers with different respective transmission rates. As discussed above, the association information may be applicable to a particular ONU 101 and/or to a group of one or more ONUs 101. As discussed above, OLT 103 may receive or determine (e.g., at 102) such information based on a registration procedure, a service provisioning procedure, a configuration procedure, and/or some other suitable procedure. As also discussed above, the different identifiers may include Alloc-IDs or other suitable identifiers. As additionally noted above, a particular Alloc-ID may be associated with other traffic attributes or characteristics, such that the particular Alloc-ID may refer to both a transmission rate as well as a queue, a traffic type, and/or other suitable traffic attributes or characteristics.

Process 500 may further include determining (at 504) scheduling for a particular ONU 101, which may include determining one or more transmission rates at which ONU 101 should transmit data. As discussed above, the scheduling information may be determined on a per-time slot basis, a per-burst window basis, and/or on some other temporal basis. For example, OLT 103 may determine increased transmission rates in order to increase throughput or other QoS or performance metrics, and may determine reduced transmission rates in order to decrease power consumption of ONU 101.

Process 500 may additionally include determining (at 506) respective identifiers associated with the determined transmission rates. For example, OLT 103 may determine (e.g., based on the maintained association of different identifiers with different transmission rates for the particular ONU 101) respective identifiers such as Alloc-IDs that are associated with the various transmission rates determined (at 504) for ONU 101. For example, out of a plurality of available transmission rates specified in the association information for ONU 101, OLT 103 may select a set or subset of the available transmission rates, as the transmission rates specified in the scheduling information for ONU 101.

Process 500 may also include providing (at 508) scheduling information to ONU 101, including the identifiers (e.g., Alloc-IDs) that were determined based on the transmission rates. As noted above, and as discussed below, ONU 101 may identify the respective transmission rates and/or other suitable traffic attributes (e.g., queues, traffic types, etc.) based on the indicated identifiers.

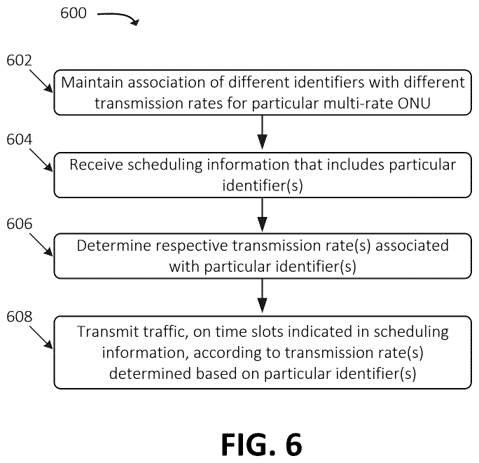

FIG. 6 illustrates an example process 600 for transmitting traffic at a variable rate and/or at multiple transmission rates based on scheduling information. In some embodiments, some or all of process 600 may be performed by a multi-rate ONU of some embodiments, such as ONU 101.

As shown, process 600 may include maintaining (at 602) an association of different identifiers with different transmission rates for one or more ONUs 101 (e.g., a particular ONU 101 and/or multiple ONUs 101). As discussed above, ONU 101 may receive (e.g., at 102) such information based on a registration procedure, a service provisioning procedure, a configuration procedure, and/or some other suitable procedure. As discussed above, the different identifiers may include Alloc-IDs or other suitable identifiers.

Process 600 may further include receiving (at 604) scheduling information that includes one or more particular identifiers (e.g., Alloc-IDs). For example, as discussed above, ONU 101 may receive scheduling information (e.g., as reflected in example data structure 301) that specifies particular identifiers (e.g., Alloc-IDs) on a temporal basis, such as for a given time slot, burst window, or the like.

Process 600 may additionally include determining (at 606) respective transmission rates (as well as queues, traffic types, etc. in some embodiments) associated with the indicated identifiers. For example, ONU 101 may identify (e.g., based on the maintained association of different identifiers with different transmission rates for the particular ONU 101) respective identifiers such as Alloc-IDs that are associated with the various transmission rates indicated (at 604) in the scheduling information. Process 600 may also include transmitting (at 608) traffic, on time slots indicated in the scheduling information, according to the transmission rates (as well as queues, traffic types, etc. in some embodiments) with which the identifiers included in the scheduling information are associated.

In one example, embodiments described above may be applied in systems that implement or adhere to PON standards, such as standards that include or specify Alloc-ID code points for messaging between OLTs and ONUs. Solutions provided by embodiments described herein allow for existing Alloc-ID code points to remain valid, while further using such Alloc-ID code points to designate multiple transmission rates applicable to different burst windows for one or more ONUs. As such, embodiments described herein preserve intact the existing Alloc-ID scheduling mechanism, allow the existing Physical Layer orbital angular momentum multiplexing (“OAM”) messaging framework to remain valid (that is, the existing code points remain valid), and use open Physical Layer OAM codepoints to designate the multiple transmit rates applicable to the burst associated with the Alloc-ID.

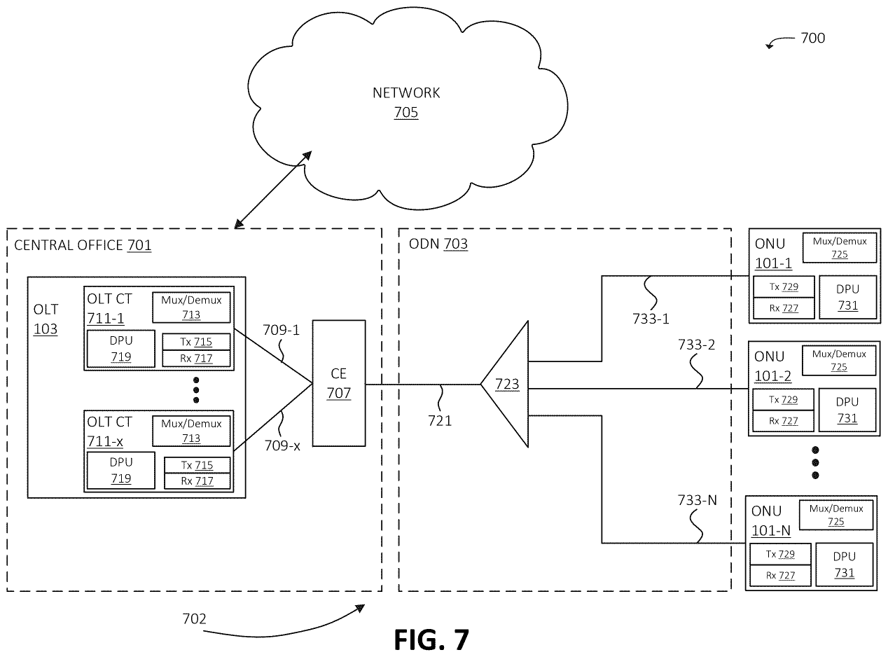

FIG. 7 is a block diagram illustrating an exemplary environment 700 in which systems and methods described herein may be implemented. As shown in FIG. 7, environment 700 may include a PON system 702 that includes central office 701, ODN 703, and a plurality of ONUs 101-1 to 101-N. Environment 700 further includes one or more networks 705.

Central office 701 may provide interconnection between a PON and transport networks (e.g., metro, long haul) that provide communications connectivity to ONUs 101. As shown in FIG. 7, central office 701 may include OLT 103 connected to Coexistence Element (“CE”) 707 via one or more channel attachment fibers 709 (e.g., channel attachment fibers 709-1, 709-x) that correspond to particular respective channel wavelengths. In some embodiments, CE may include, may implement, may be implemented by, and/or may otherwise be associated with a CE/wavelength multiplexer/demultiplexer (“WM”).

In TDM implementations, OLT 103 may include a single OLT channel termination (“CT”) 711 and may be coupled to CE 707 via a single channel attachment fiber 709, while in TWDM implementations, OLT 103 may include a plurality (e.g., four) of OLT CTs 711-1 to 711-x, each corresponding to a particular channel wavelength, and may be coupled to CE 707 via a corresponding plurality of channel attachment fibers 709. OLT CTs 711-1 to 711-x may be referred to collectively as OLT CTs 711, or individually or generally as OLT CT 711. OLT CTs 711 may correspond, for example, to optical blades or cards associated with optical signals carried via a PON, such as ODN 703, to ONUs 101. OLT CTs 711 may communicate with a customer premises via ODN 703 to provide data and/or services to the customer premises.

Each of OLT CTs 711 may include a respective multiplexer/demultiplexer 713, optical transmitter 715, optical receiver 717, and data processing unit (“DPU”) 719 for transmitting, receiving, and processing optical signals to/from channel attachment fibers 709.

Each optical transmitter 715 may be configured to output a modulated optical signal having a corresponding optical wavelength. Each optical receiver 717 may include a coherent receiver. DPU 719 may include a Digital Signal Processing (“DSP”) or Automatic Gain Control (“AGC”) unit. Coherent receivers may coherently detect, and analog-to-digital convert modulated optical signals of a particular wavelength. The coherent receiver may pass the resulting digital signals to the DPU 719 for signal processing.

Functions of OLT CTs 711 may be governed by one or more system management components coupled to central office 701 (e.g., via one or more networks 705, which may include a backhaul network). For example, such system management components may include a control and management system (“CMS”) and/or system orchestrator (“SO”) configured to set up, manage, and monitor PON system 702.

ODN 703 may include a trunk fiber 721 coupled to CE 707 and an optical splitter 723, and a plurality of distribution or branch fibers 733, such as distribution or branch fibers 733-1, 733-2, 733-N, etc., to connect splitter 723 and ONUs 101. Although not depicted in FIG. 7 for simplicity, ODN 703 may include various additional components associated with a PON system 702. For example, ODN 703 may include various passive optical components such as filters, attenuators, etc. ODN 703 may also include multiple “levels” of optical splitters 723 to increase the fanout of the ODN 703. For example, trunk fiber 721 may connect to a first optical splitter 723, and a “feeder” fiber may connect the first optical splitter to a second optical splitter 723. Distribution or branch fibers 733 may be connected to second optical splitter 723. Some implementations may use further levels of splitting.

ONUs 101 include devices to terminate distribution or branch fibers 733 at customer premises. ONUs 101 may demultiplex incoming optical signals into component parts (such as voice telephone, television, and Internet), and provide the signals to user devices in customer premises. ONUs 101 may also transmit outgoing signals from devices in customer premises back to central office 701 via ODN 703.

As described above, each of OLT CTs 711 may be associated with a separate wavelength or range of wavelengths for sending downstream signals. Similarly, ONUs 101 may be associated with separate wavelengths or ranges of wavelengths for sending upstream signals back to central office 701. Each of ONUs 101 may include a respective multiplexer/demultiplexer 725, optical receiver 727, optical transmitter 729, and DPU 731.

Although FIG. 7 illustrates exemplary components of environment 700, in other implementations, environment 700 may include fewer components, different components, differently arranged components, and/or additional components than those depicted in environment 700. Also, functions described as being performed by respective separate components of environment 700 may be performed by a single component, or a single function may be performed by multiple components of environment 700.

Furthermore, in FIG. 7, the depicted particular arrangement and number of components of environment 700 are illustrated for simplicity. In practice, there may be more or fewer central offices 701, ODNs 703, ONUs 101, OLTs 103, or OLT CTs 711 than depicted in FIG. 7. For example, there may be dozens of central offices 701 associated with a network environment, and tens or even hundreds of OLT CTs 711 associated with a single central office 701.

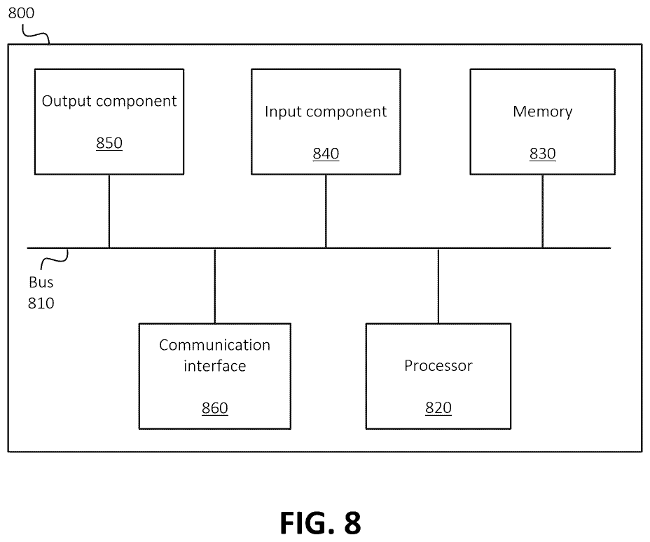

FIG. 8 illustrates example components of device 800. One or more of the devices described above may include one or more devices 800. Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 820 may be or may include one or more hardware processors. Memory 830 may include any type of dynamic storage device that may store information and instructions for execution by processor 820, and/or any type of non-volatile storage device that may store information for use by processor 820.

Input component 840 may include a mechanism that permits an operator to input information to device 800 and/or other receives or detects input from a source external to input component 840, such as a touchpad, a touchscreen, a keyboard, a keypad, a button, a switch, a microphone or other audio input component, etc. In some embodiments, input component 840 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 850 may include a mechanism that outputs information to the operator, such as a display, a speaker, one or more light emitting diodes (“LEDs”), etc.

Communication interface 860 may include any transceiver-like mechanism that enables device 800 to communicate with other devices and/or systems (e.g., via RAN $a10, RAN $a12, DN $a50, etc.). For example, communication interface 860 may include an Ethernet interface, an optical interface, a coaxial interface, or the like. Communication interface 860 may include a wireless communication device, such as an infrared (“IR”) receiver, a Bluetooth^{®}radio, or the like. The wireless communication device may be coupled to an external device, such as a cellular radio, a remote control, a wireless keyboard, a mobile telephone, etc. In some embodiments, device 800 may include more than one communication interface 860. For instance, device 800 may include an optical interface, a wireless interface, an Ethernet interface, and/or one or more other interfaces.

Device 800 may perform certain operations relating to one or more processes described above. Device 800 may perform these operations in response to processor 820 executing instructions, such as software instructions, processor-executable instructions, etc. stored in a computer-readable medium, such as memory 830. A computer-readable medium may be defined as a non-transitory memory device. A memory device may include space within a single physical memory device or spread across multiple physical memory devices. The instructions may be read into memory 830 from another computer-readable medium or from another device. The instructions stored in memory 830 may be processor-executable instructions that cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
maintain association information that associates a plurality of identifiers with a plurality of transmission rates;
determine scheduling information for a particular Optical Network Unit (“ONU”) of an Optical Distribution Network (“ODN”), wherein determining the scheduling information includes determining different transmission rates for a plurality of different transmission intervals;
determine a set of identifiers, of the plurality of identifiers, that are indicated in the association information as being associated with the transmission rates included in the scheduling information; and
instruct the ONU to implement the scheduling information, wherein instructing the ONU to implement the scheduling includes providing the scheduling information with the set of identifiers to the ONU.

2. The device of claim 1, wherein the plurality of identifiers include a plurality of allocation identifiers (“Alloc-IDs”).

3. The device of claim 1, wherein the ONU identifies particular transmission rates for particular transmission intervals based on the set of identifiers included in the provided scheduling information.

4. The device of claim 1, wherein the scheduling information includes uplink scheduling information, and wherein the transmission rates include uplink transmission rates.

5. The device of claim 1, wherein the one or more processors are further configured to identify a plurality of queues implemented by ONU, wherein determining the scheduling information for the particular ONU includes:
specifying a first transmission rate for a first queue on a first transmission interval; and
specifying a second transmission rate for the first queue on a second transmission interval.

6. The device of claim 5, wherein determining the set of identifiers includes:
determining a first identifier, of the plurality of identifiers, that is associated with the first transmission rate; and
determining a second identifier, of the plurality of identifiers, that is associated with the second transmission rate.

7. The device of claim 1, wherein the scheduling information is determined for a scheduling cycle of at least one physical layer frame, and wherein the scheduling information is determined for each scheduling cycle within an activation cycle.

8. A non-transitory computer-readable medium, storing a plurality of processor-executable instructions to:
maintain association information that associates a plurality of identifiers with a plurality of transmission rates;
determine scheduling information for a particular Optical Network Unit (“ONU”) of an Optical Distribution Network (“ODN”), wherein determining the scheduling information includes determining different transmission rates for a plurality of different transmission intervals;
determine a set of identifiers, of the plurality of identifiers, that are indicated in the association information as being associated with the transmission rates included in the scheduling information; and
instruct the ONU to implement the scheduling information, wherein instructing the ONU to implement the scheduling includes providing the scheduling information with the set of identifiers to the ONU.

9. The non-transitory computer-readable medium of claim 8, wherein the plurality of identifier includes a plurality of allocation identifiers (“Alloc-IDs”).

10. The non-transitory computer-readable medium of claim 8, wherein the ONU identifies particular transmission rates for particular transmission intervals based on the set of identifiers included in the provided scheduling information.

11. The non-transitory computer-readable medium of claim 8, wherein the scheduling information includes uplink scheduling information, and wherein the transmission rates include uplink transmission rates.

12. The non-transitory computer-readable medium of claim 8, wherein the plurality of processor-executable instructions further include processor-executable instructions to identify a plurality of queues implemented by ONU, wherein determining the scheduling information for the particular ONU includes:
specifying a first transmission rate for a first queue on a first transmission interval; and
specifying a second transmission rate for the first queue on a second transmission interval.

13. The non-transitory computer-readable medium of claim 12, wherein determining the set of identifiers includes:
determining a first identifier, of the plurality of identifiers, that is associated with the first transmission rate; and
determining a second identifier, of the plurality of identifiers, that is associated with the second transmission rate.

14. The non-transitory computer-readable medium of claim 8, wherein the scheduling information is determined for a scheduling cycle of at least one physical layer frame, and wherein the scheduling information is determined for each scheduling cycle within an activation cycle.

15. A method, comprising:
maintaining association information that associates a plurality of identifiers with a plurality of transmission rates;
determining scheduling information for a particular Optical Network Unit (“ONU”) of an Optical Distribution Network (“ODN”), wherein determining the scheduling information includes determining different transmission rates for a plurality of different transmission intervals;
determining a set of identifiers, of the plurality of identifiers, that are indicated in the association information as being associated with the transmission rates included in the scheduling information; and
instructing the ONU to implement the scheduling information, wherein instructing the ONU to implement the scheduling includes providing the scheduling information with the set of identifiers to the ONU.

16. The method of claim 15, wherein the plurality of identifiers include a plurality of allocation identifiers (“Alloc-IDs”).

17. The method of claim 15, wherein the ONU identifies particular transmission rates for particular transmission intervals based on the set of identifiers included in the provided scheduling information.

18. The method of claim 15, wherein the scheduling information includes uplink scheduling information, and wherein the transmission rates include uplink transmission rates.

19. The method of claim 15, further comprising identifying a plurality of queues implemented by ONU, wherein determining the scheduling information for the particular ONU includes:
specifying a first transmission rate for a first queue on a first transmission interval;
determining a first identifier, of the plurality of identifiers, that is associated with the first transmission rate;
specifying a second transmission rate for the first queue on a second transmission interval; and
determining a second identifier, of the plurality of identifiers, that is associated with the second transmission rate.

20. The method of claim 15, wherein the scheduling information is determined for a scheduling cycle of at least one physical layer frame, and wherein the scheduling information is determined for each scheduling cycle within an activation cycle.
